(19) United States
(12) Patent Application Publication
(10) Pub. No.: US 2010/0027058 A1
(43) Pub. Date: Feb. 4, 2010

(54) IMAGE SENDING APPARATUS

(75) Inventor: Mikiya Okada, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/502,480

(22) Filed: Jul. 14, 2009

(30) Foreign Application Priority Data
Jul. 29, 2008 (JP) 2008-194814

(51) Int. Cl. G06F 3/12; G06F 3/041; G09G 5/00

(52) U.S. Cl. 358/1.15; 345/173; 345/671

(57) ABSTRACT

A digital multi-functional peripheral is provided with a touch panel for displaying various information, a reading portion for reading an original and inputting image data, an NCU for sending the image data, a preview image generating portion for generating a preview image of the image data, and a panel control portion for causing the touch panel to display the preview image of the image data before performing image sending by the NCU. When an instruction to start reading of an original by a user is received, the panel control portion causes the touch panel to display a sending destination confirmation screen for confirming a sending destination of the image data, and after the confirmation input is performed by the user to the sending destination confirmation screen, causes the touch panel to display the preview image of the image data.

### CROSS-NOTING PARAGRAPH

This non-provisional application claims priority under 35 U.S.C. §119 (a) on Patent Application No. 2008-194814 filed in JAPAN on Jul. 29, 2008, the entire contents of which are hereby incorporated herein by reference.

### FIELD OF THE INVENTION

The present invention relates to an image sending apparatus, and to an image sending apparatus capable of displaying a preview of image data to be sent.

### BACKGROUND OF THE INVENTION

Conventionally, some image sending apparatuses such as facsimile apparatuses, internet facsimile apparatuses, or multi-functional peripherals provided with either one of or both of the apparatuses have a function of displaying a preview of image data to be sent.

For example, there is an image sending apparatus that displays a preview of the image data targeted for image formation when performing image formation (printing) of image data of an original read by a scanner or image data sent from an external device and is able to perform an image sending after a user confirmed the display.

For example, Japanese Laid-Open Patent Publication No. 2007-166201 describes an information processing apparatus in which, after finishing a destination setting and reading processing of sending original data in FAX sending, sending destination information including a destination and a preview image of sending data are displayed on a display portion.

However, the information processing apparatus described in Japanese Laid-Open Patent Publication No. 2007-166201 merely displays the preview image and the destination information at the same time and does not prompt a user to confirm the destination information. Thus, when there is an error in a destination of FAX, there is a possibility that the user performs a setting change while viewing the preview without noticing the error in the destination and sends the FAX. If a document to be sent by FAX is an extremely important confidential document or the like, it is considered that information thereof is leaked to a malicious third party, which may give a significant damage to a corporation or the like. Even when the user notices the error in the destination, a destination setting screen is not returned automatically, thus the user is given a great burden of operation.

### SUMMARY OF THE INVENTION

An object of the present invention is to provide an image sending apparatus that, in sending image data, performs destination confirmation before a preview display so that unnecessary setting change processing is not performed for an incorrect destination.

Another object of the present invention is to provide an image sending apparatus that includes a display portion for displaying various information; an original reading portion for reading an original and inputting image data; an image sending portion for sending the image data; a preview image generating portion for generating a preview image of the image data; and a display control portion for causing the display portion to display the preview image of the image data before performing image sending by the image sending portion, wherein when an instruction to start original reading by a user is received, the display control portion causes the display portion to display a sending destination confirmation screen for confirming a sending destination of the image data, and after confirmation input is performed by the user to the sending destination confirmation screen, causes the display portion to display the preview image of the image data.

Another object of the present invention is to provide the image sending apparatus, wherein the display control portion executes processing of causing the display portion to display the sending destination confirmation screen in parallel with original reading processing by the original reading portion and preview image generation processing by the preview image generating portion.

Another object of the present invention is to provide the image sending apparatus, wherein the image sending portion sends the image data by any of send modes including an electronic mail send mode for sending the image data by attaching to an electronic mail, a facsimile send mode for sending the image data by facsimile, an internet facsimile send mode for sending the image data by internet facsimile, and an external file server send mode for sending the image data to an external file server.

Another object of the present invention is to provide the image sending apparatus, wherein an input portion for inputting at least one or more of text, numeral, and symbol is included, and when the user inputs destination information of the sending destination of the image data by the input portion, the display control portion displays a message for requesting reinput of the destination information in the sending destination confirmation screen.

Another object of the present invention is to provide the image sending apparatus, wherein when the display portion is caused to display a destination information list in which destination information of sending destinations of the image data is made into a list so as to be selectable by the user, the display control portion prohibits to select a plurality of destination information from the destination information list.

Another object of the present invention is to provide the image sending apparatus, wherein when a sending setting item that is set to the image sending apparatus is reset after the display portion is caused to display the preview image, the display control portion causes the display portion to display a sending setting item corresponding to a send mode of the image sending portion.

Another object of the present invention is to provide the image sending apparatus, wherein the display control portion displays an image send key in a display screen of the preview image.

Another object of the present invention is to provide the image sending apparatus, wherein in displaying the preview image of the image data, the display control portion displays a specific area of the image data that is previously designated by the user after magnification.

### BRIEF DESCRIPTION OF THE DRAWINGS

FIG. 1 is a schematic diagram for showing an exemplary configuration of an image processing system constructed by using a digital multi-functional peripheral as an example of an image sending apparatus according to an embodiment of the present invention;

FIG. 2 is a schematic block diagram for showing an exemplary configuration of the digital multi-functional peripheral of FIG. 1;

FIG. 3 is an external view for showing an example of a touch panel and a key operation portion in the digital multi-functional peripheral of FIG. 2;

FIG. 4 is a diagram for showing an example of a standard screen of the digital multi-functional peripheral;

FIGS. 5A and 5B are flowcharts for explaining an example of preview display processing by the digital multi-functional peripheral of the present invention;

FIG. 6 is a flowchart for explaining an example of preview display processing by the digital multi-functional peripheral of the present invention;

FIGS. 7A and 7B are flowcharts for explaining an example of preview display processing by the digital multi-functional peripheral of the present invention;

FIG. 8 is a diagram for showing an example of a standard screen of an image send mode;

FIG. 9 is a diagram for showing an example of a standard screen of an image send mode;

FIG. 10 is a diagram for showing an example of a standard screen of an image send mode;

FIG. 11 is a diagram for showing an example of a standard screen of an image send mode;

FIG. 12 is a diagram for showing an example of an address book screen on which one-touch input of a destination is possible;

FIG. 13 is a diagram for showing an example of a destination confirmation screen displayed at the time of destination one-touch input;

FIG. 14 is a diagram for showing an example of a destination confirmation screen displayed at the time of destination manual input;

FIGS. 15A and 15B are diagrams for showing an example of a preview display screen; and

FIG. 16 is a diagram for showing an example of a preview resetting screen.

### PREFERRED EMBODIMENTS OF THE INVENTION

Now, a preferred embodiment according to an image sending apparatus of the present invention will hereinafter be described with reference to the accompanying drawings. An embodiment in which the image sending apparatus according to the present invention is applied to a digital multi-functional peripheral having a print function, a copy function, and a facsimile sending and receiving function, etc., will hereinafter be described specifically with reference to the drawings showing the embodiment.

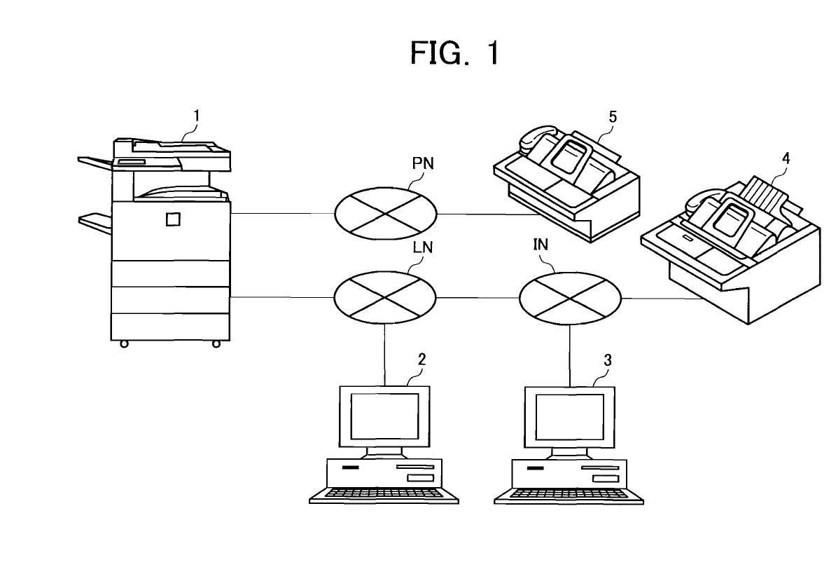

FIG. 1 is a schematic diagram for showing an exemplary configuration of an image processing system constructed by using a digital multi-functional peripheral as an example of an image sending apparatus according to an embodiment of the present invention. In FIG. 1, 1 denotes a digital multi-functional peripheral, 2 and 3 denote external computers, 4 denotes an internet facsimile apparatus (internet FAX apparatus), and 5 denotes a facsimile apparatus.

The digital multi-functional peripheral 1 is one of embodiments of the image sending apparatus of the present invention and has a print function and a copy function, as well as a function of sending and receiving image data by facsimile (facsimile function) and/or a function of sending and receiving image data by internet FAX (internet FAX function). This digital multi-functional peripheral 1 is connected to various external devices through a communication network. For example, the external computer 2 such as a personal computer (PC) is connected to a communication network LN that is laid as a local communication network, and the external computer 3 and the internet FAX apparatus 4 are connected to an internet network IN that is connected through a gateway (not-shown) or the like. Further, the external facsimile apparatus 5 is connected to the digital multi-functional peripheral 1 through a public telephone line network PN.

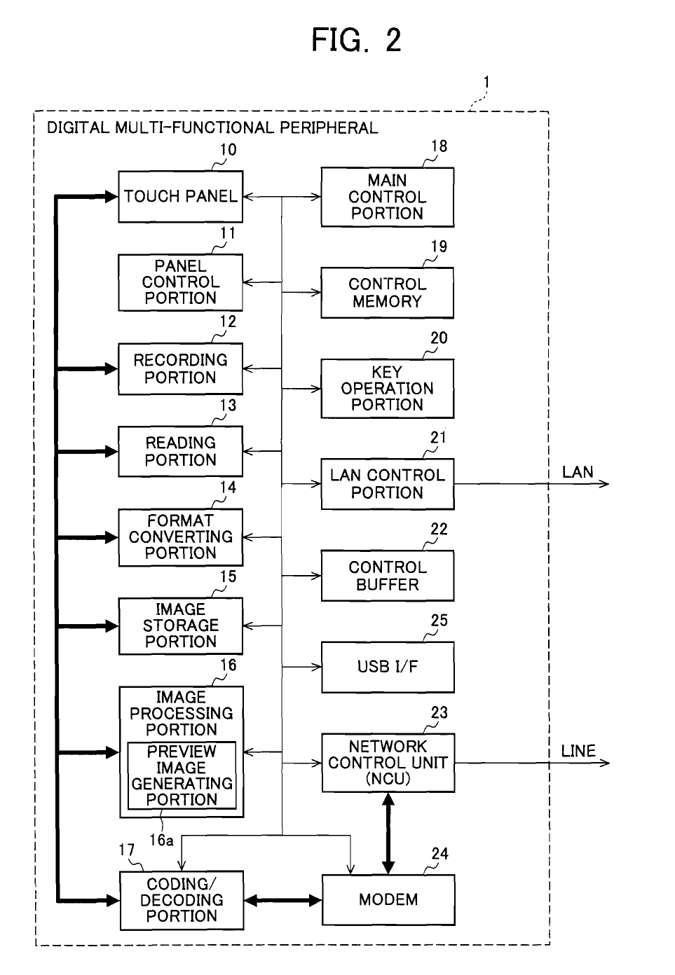

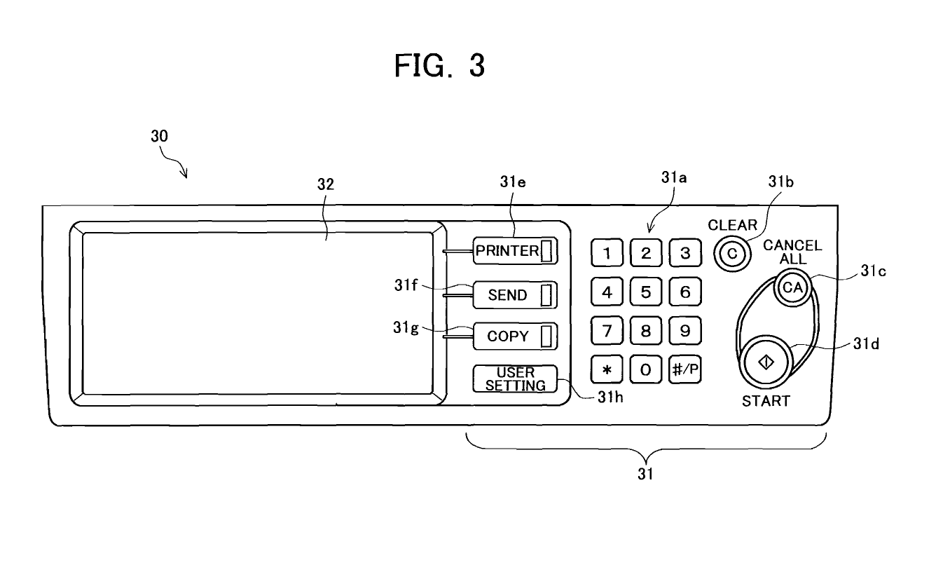

Description will be given for a configuration and an operation of the digital multi-functional peripheral 1. FIG. 2 is a schematic block diagram for showing an exemplary configuration of the digital multi-functional peripheral of FIG. 1, and FIG. 3 is an external view for showing an example of a touch panel and a key operation portion of the digital multi-functional peripheral of FIG. 2.

The digital multi-functional peripheral 1 illustrated in FIG. 2 is provided with a touch panel 10, a panel control portion 11, a recording portion 12, a reading portion 13, a format converting portion 14, an image storage portion 15, an image processing portion 16, a coding/decoding portion 17, a main control portion 18, a control memory 19, a key operation portion 20, a LAN (Local Area Network) control portion 21, a control buffer 22, a network control unit (NCU) 23, a modem 24, and an USB (Universal Serial Bus: Registered Trademark) interface (I/F) 25.

The main control portion 18 is comprised of a CPU (Central Processing Unit), a DSP (Digital Signal Processor), or the like. The control memory 19 is comprised of a nonvolatile memory or the like, such as a ROM (Read Only Memory) or an EEPROM (Electrically Erasable and Programmable ROM). A program (firmware) and various setting data are stored in the control memory 19 so as to be readable from the main control portion 18. Among them, at least various setting data is stored in a rewritable memory. The program and the various setting data may be stored in the image storage portion 15. The control buffer 22 is comprised of a volatile memory such as a RAM (Random Access Memory).

The above-described program is used for the main control portion 18 to carry out commands concerning generation and display of a preview image, which will be described below, according to the present invention, as well as commands concerning generation/sending /reception, etc., of a facsimile image and an electronic mail, etc., a command concerning reading of an original, a command concerning printing, a command concerning reading and printing (that is, copying) of an original, and the like, with respect to other parts. This program is developed by the main control portion 18 on the control buffer 22 and is executed by referring to various setting data appropriately, which will be described below, using the control buffer 22 as a data area for temporal storing (working).

The reading portion 13 reads an original as a bitmap image of RGB (R: Red, G: Green, and B: Blue) with a predetermined resolution by a scanner using a CCD (Charge Coupled Device) and outputs the read RGB image data (dot image data) to the image processing portion 16. The image processing portion 16 is comprised of an ASIC (Application Specific Integrated Circuit) or the like, and applies various image processing to target image data. The ASIC may be incorporated with other parts such as the coding/decoding portion 17.

The image storage portion 15 is comprised of hard disc or the like, and stores image data that has been read by the reading portion 13 and has passed through the image processing portion 16, image data that has been received from outside through the LAN control portion 21, the NCU 23, etc., and the like. When image data is stored in the image storage portion 15, data that has been coded by the coding/decoding portion may be also stored. Moreover, the image storage portion 15 may temporarily save intermediate data generated during image processing at the image processing portion 16.

The coding/decoding portion 17 compresses image data by coding and decodes (expands) the coded image data to original image data. For example, the coding/decoding portion 17 performs coding of image data read from an original, decoding of the coded data, decoding of coded image data received from outside, and the like. In the coding/decoding portion 17, coding systems corresponding to purposes are usable, including JPEG (Joint Photographic Experts Group) that is generally used in filing, and MH (Modified Huffman), MR (Modified READ) and MMR (Modified Modified READ) that are generally used in facsimile communication. As the coding system, MH is employable in IP facsimile communication, and MH, MR, and MMR as well as JPEG and JBIG (Joint Bi-level Image Experts Group) are employable in internet facsimile communication.

The format converting portion 14 converts read image data or image data received from outside into a predetermined file format such as a PDF (Portable Document Format), a GIF (Graphics Interchange Format), or a TIFF (Tag Image File Format).

The recording portion 12 is provided with a printer apparatus that employs a printing system such as an electrophotographic system or an inkjet system, and functions as image forming means that records (that is, prints) image data and the like stored in the image storage portion 15 on recording paper. The USB I/F 25 is an I/F for connecting to a USB device such as a USB memory, and outputs image data and the like after original reading that is stored in the image storage portion 15 or reads a file from the USB device.

The modem 24 is comprised of a facsimile modem capable of facsimile communication, and is connected to a telephone line and is directly connected to the NCU 23. The NCU 23 is connected to the telephone line to control the line. That is, the NCU 23 is a hardware that performs an operation of closing and opening the line with an analogue public switched telephone network (PSTN), and connects the modem 24 to the public switched telephone network as the occasion demands. Such a configuration makes it possible to send image data stored in the image storage portion 15 to outside by facsimile or to receive facsimile image data from the telephone line, to store the data in the image storage portion 15, or to print the data by the recording portion 12 directly.

The LAN control portion 21 is connected to a LAN and performs communication of electronic mail data and communication of internet FAX via an internet. The internet FAX uses a LAN interface or the like to send and receive an electronic mail through a computer network such as a LAN.

The touch panel 10 or the key operation portion 20 is an operation input portion that receives an operation for selecting desired processing out of processing of reading an original, processing of sending image data and printing, etc., an operation for starting the processing, an operation for performing a setting that is necessary when each processing is executed (a selecting operation or an inputting operation), and the like.

The key operation portion 20 is provided with a key group necessary for operations. The touch panel 10 has a display portion and an operation receiving portion such as a touch sensor. The touch panel 10 accepts a display control and an operation reception control from the panel control portion 11. That is, the panel control portion 11 performs the display control for the display portion and the operation reception control for the operation receiving portion in the touch panel 10.

On the display portion of the touch panel 10, a current operating state, setting information and the like are displayed. The display is realized when the panel control portion 11 performs control to display a GUI (Graphical User Interface) image. The display and an operation reception position can be changed depending on a user operation using the GUI. Each GUI and an image thereof may be stored so as to be readable in an internal memory of the panel control portion 11 or the control memory 19. In addition, as the display portion, display devices in various display systems including liquid crystal displays and organic EL (Electroluminescence) displays are employable.

The user operation received on the touch panel 10 is interpreted by the panel control portion 11 and is transmitted as an operation signal to the main control portion 18. The user operation received by the key operation portion 20 is interpreted by the key operation portion 20 itself and transmitted as an operation signal to the main control portion 18. The main control portion 18 issues a command in accordance with the operation signal obtained in this manner to other portions to cause other portions to execute the processing in accordance with the user operation. Note that, although description has been given with reference to the touch panel in which the display device and the operation portion are integrated, only the display apparatus may be simply provided instead of the touch panel 10 and, in that case, where the user operation is received only by the key operation portion 20.

The touch panel 10 and the key operation portion 20 are configured as an operation panel 30 as illustrated in FIG. 3. In this example, the operation panel 30 is comprised of a key operation portion 31 (corresponding to the key operation portion 20) provided with various hardware keys and a touch panel 32 (corresponding to the touch panel 10) comprising a liquid crystal display and a touch sensor. The present invention will hereinafter be described in detail with the touch panel 32 and the key operation portion 31 applied to the configuration of FIG. 1 instead of the touch panel 10 and the key operation portion 20.

The key operation portion 31 is provided with, as hardware keys, a ten key 31a for inputting numeric values, a clear key 31b for clearing input set values, a cancel all key 31c for canceling all of various input settings, and a start key (start button) 31d for receiving instructions of start of copying, start of sending, etc., as well as function switch keys 31e, 31f, and 31g for switching a print function, a sending function and a copy function, and a system setting key 31h for receiving a setting by a user.

An exemplary operation in the digital multi-functional peripheral 1 having the above-described exemplary configuration will be described.

### <Original Reading Operation>

An original reading operation is performed when image data of a read original is stored (filed) in the image storage portion 15, when image data of a read original is sent to outside, when image data of a read original is printed (that is, copied), and the like.

When a user operation to perform the processing like that requires original reading is received by the operation panel 30, the main control portion 18 gives an instruction to the reading portion 13, the image storage portion 15, the image processing portion 16, the coding/decoding portion 17, and causes them to execute the processing that is described below.

The reading portion 13 optically reads an image of an original placed on a document platen or an automatic document feeder and provides the image processing portion 16 with RGB image data (bitmap data of RGB) as a result of reading. The image processing portion 16 executes various image processing (hereinafter, referred to as original image processing) such as A/D conversion, shading correction, and γ correction for the RGB image data. Here, the shading processing is the processing to remove various distortions generated in an illumination system, an image focusing system, and an image sensing system of the reading portion 13.

As the original image processing, original determination processing and segmentation processing may be executed subsequently to the A/D conversion, the shading correction, and the γ correction. The original determination processing includes processing of determining a type of the original and processing of determining whether the original is a color original or a monochromatic original based on input image data (image data after the application of the γ correction, in this case). Examples of the type of the original include a text original, a printed photograph original, and text and printed photograph original in combination thereof. The image processing portion 16 outputs a determination signal (hereinafter, referred to as original determination data) as a result of the original type determination processing and the monochromatic/color original determination processing.

The segmentation processing is the processing of determining to what kind of area each pixel of the input image data (image data after the application of the γ correction, in this case) belongs, and an example thereof includes the processing of determining to which area such as a black text area, a color text area or a halftone area each pixel belongs. The image processing portion 16 outputs segmentation data as a result of the determination. Note that, the segmentation processing may be executed based on the result of the above-described original determination processing and monochromatic/color original determination processing.

The original determination data and the segmentation data are stored in the image storage portion 15 in association with corresponding image data (image data after the application of the original image processing). At this time, the original determination data and the segmentation data are coded by the coding/decoding portion 17 and each coded data is thereafter stored in the image storage portion 15 in association with the corresponding image data. Note that, although the coding is not essential when storing image data in the image storage portion 15, description will be given assuming that the image data is stored in a state of being coded. This is also the same in operations other than the original reading operation.

### <Printing Operation>

By the above-described original reading operation, processing up to filing of the image data of the read original is completed. Next, description will be given for a printing operation when the image data of the read original is printed (formed image) (that is, when the original is copied). When the user operation to perform the processing like that requires printing is received by the operation panel 30, the main control portion 18 gives an instruction to the recording portion 12, the image storage portion 15, the image processing portion 16, the coding/decoding portion 17, and causes them to execute the processing that is described below. Note that, the main control portion 18 also gives an instruction to the reading portion 13 (original reading instruction), for example, when a copy operation is performed.

The coding/decoding portion 17 reads and decodes image data to be printed and original determination data and segmentation data corresponding thereto from the image storage portion 15, and gives the decoded image data to the image processing portion 16. The image processing portion 16 executes various image processing (hereinafter, referred to as image processing for printing) for the decoded image data (RGB image data). As will be schematically described below, examples of the image processing for printing include image quality adjustment processing, two-color processing, color correction processing, black generation and under color removal processing, spatial filtering processing, scaling processing, output tone correction processing, and halftone generation processing. Each of the black generation and under color removal processing, the spatial filtering processing, and the halftone generation processing is the processing in accordance with various areas indicated by the segmentation data, respectively.

As the image quality adjustment processing, a background is detected from the decoded image data to perform background removal. Moreover, as the image quality adjustment processing, RGB adjustment (color adjustment; entire color adjustment of redness or blueness), brightness adjustment, and vividness adjustment are also performed for the image data after the application of the background removal based on setting information set by a user from the operation panel 30. At this time, adjustment in accordance with an original type indicated by the original determination data may be performed.

As the color correction processing, CMY data having components of CMY (C: Cyan, M: Magenta, Y: Yellow) which are complementary colors of RGB is generated from the RGB data after the application of the image quality adjustment processing and processing of enhancing color reproduction is performed. As the black generation and under color removal processing, black generation processing of generating black (K) data from the CMY data after the application of the color correction and under color removal processing of subtracting the K data obtained by the black generation from the original CMY data to generate new CMY data.

As the spatial filtering processing, enhancement processing and smoothing processing is performed for CMYK data which is data of the four colors. When a two-color mode for outputting the image data in two colors (for example, red and black) is selected, the two-color processing is performed. As the two-color processing, processing of converting the RGB data into CMY data that represents specified two colors (red and black in this case) is performed. In the case of the two-color mode, the black generation and under color removal processing is executed for the CMY data after the application of the two-color processing and the spatial filtering processing is also executed, however, the color correction processing is not performed.

As the scaling processing, image enlarging processing or image reducing processing is performed for the CMYK data after the application of the spatial filtering processing based on a printing copy ratio set by the user operation from the operation panel 30. The printing copy ratio is a copy ratio of a printed image for the image indicated by read and stored image data. Of course, the printing copy ratio is not limited to a copy ratio obtained by the user operation and is a copy ratio set as default when no operation is performed for the printing copy ratio.

As the output tone correction processing, output γ correction processing of outputting to a recording medium such as recording paper is performed for the CMYK data. As the halftone generation processing, tone reproduction processing of outputting an image by error diffusion processing and dither processing is performed for the CMYK data after the application of the output tone correction processing. In the output tone correction processing and the halftone generation processing, processing in accordance with an original type indicated by the original determination data may be performed, for example, including differentiating processing contents between a text area and other areas.

The CMYK data after the application of the halftone generation processing is provided to the recording portion 12. The recoding portion 12 receives the image data to which the image processing for printing has been given by the image processing portion 16 in this manner (the CMYK image data in this example) and generates a hard copy (prints out) by an electrophotographic system or an inkjet system. Note that, the data targeted for the printing operation described here is not limited to the image data read by the reading portion 13, and, for example, image data (image file) that has been previously transferred from an external recoding medium, a PC connected through a network, or the like and stored in the image storage portion 15 is also applicable in the same manner. The printing operation for the image data that has been received by facsimile and stored in the image storage portion 15 will be described below.

### <Preview Display Operation for Image Data to be Printed>

Next, description will be given for an operation of displaying a preview of image data stored in the image storage portion 15 as a result of reading an original on the touch panel 32 before printing (preview display operation). The preview display operation is performed when the user operation to perform processing that requires the preview display is received by the operation panel 30. For example, the preview display operation is also performed, when a setting is made such that a preview of the image data after the original reading is displayed before executing printing.

In the preview display operation, the main control portion 18 gives an instruction to the image storage portion 15, the image processing portion 16, the coding/decoding portion 17, the panel control portion 11, and the like to execute the processing as will be described below. Note that, the main control portion 18 also gives an instruction to the reading portion 13 (original reading instruction), for example, when an operation of copying an original is performed.

The coding/decoding portion 17 reads and decodes image data to be displayed for previewing and original determination data and segmentation data corresponding thereto from the image storage portion 15, which is provided to the image processing portion 16. The image processing portion 16 executes various image processing (hereinafter, referred to as image processing for previewing) for the decoded image data (RGB image data).

As will be schematically described below, examples of the image processing for previewing include image quality adjustment processing, two-color processing, color correction processing, spatial filtering processing, scaling processing, and output tone correction processing. Each of the spatial filtering processing and the output tone correction processing is the processing in accordance with various areas indicated by the segmentation data, respectively.

The image quality adjustment processing here is the same as the image quality adjustment processing in the image processing for printing. As the color correction processing, processing of converting the image data after the application of the image quality adjustment processing (RGB data) into R′G′B′ data based on display characteristics of the touch panel 32. As the spatial filtering processing, enhancement processing or smoothing processing is performed for the R′G′B′ data.

As the scaling processing, image enlarging processing/image reducing processing in accordance with a printing copy ratio is applied to the R′G′B′ data after the application of the spatial filtering processing, and processing of converting a pixel number of the R′G′B′ data into a pixel number (display resolution) of the touch panel 32 is performed and image enlarging processing or image reducing processing is performed based on a preview display magnification set by the user operation from the operation panel 30 at the same time. The preview display magnification is a fixed display maginification such as twice and four times, for example, and is a display magnification of an image in the preview display. Of course, the preview display magnification is not limited to a display magnification obtained by the user operation, and is a display magnification set as default when no operation is performed for the preview display magnification.

A preview image generating portion 16a provided in the image processing portion 16 generates an image for the preview display (preview image) mainly by such scaling processing for the preview display.

As the output tone correction processing, output γ correction processing of displaying image data on the touch panel 32 is performed for the R′G′B′ data of the preview image. In the output tone correction processing, processing in accordance with an original type indicated by the original determination data may be performed, for example, including differentiating processing contents between a text area and other areas.

The two-color processing is executed only when a two-color mode for outputting image data in two colors of red and black, for example, is selected. As the two-color processing, processing of converting the RGB data after the application of the image quality adjustment processing into CMY data that represents specified two colors (red and black in this case) is performed. The generated CMYK data is converted into R′G′B′ data based on display characteristics of the touch panel 32 at the subsequent color correction processing.

The R′G′B′ data generated by the preview image generating portion 16a and dealt with by means of the output tone correction processing is provided to the touch panel 32. The panel control portion 11 performs control for the touch panel 32 to display an image corresponding to the R′G′B′ data in a state of being incorporated in a GUI image and displays the GUI image on the touch panel 32.

Note that, the data targeted for the preview display operation described here is not limited to the image data read by the reading portion 13, and image data (image file) that has been previously transferred from an external recording medium, a PC connected through a network, or the like and stored in the image storage portion 15, for example, is also applicable in the same manner.

### <Supplement for Original Reading, Preview Display and Printing>

Although description has been given for the preview display operation separately from the printing operation, the printing operation may be performed such that the image data (CMYK data) after the application of the output tone correction processing is converted into the R′G′B′ data based on display characteristics of the touch panel 32, is processed by conversion processing corresponding to a pixel number (display resolution) of the touch panel 32 and scaling processing corresponding to a reducing/enlarging ratio in the preview display, and is displayed on the touch panel 32. Since the printing operation is completed to a certain extent and the printing operation after the preview display can be completed quickly, it is useful in a case where a setting is made such that a preview is previously displayed, for example, when the copy operation is performed.

In addition, an example in which the coded image data, the original type data and the segmentation data are stored in the image storage portion 15 in association with one another has been taken as the original reading operation, the printing operation and the preview display operation have been also described and based on the example. As an alternative method thereof, coding may be performed only for the image data read by the reading portion 13, and the coded image data may be temporarily stored in the image storage portion 15. In this case, it may be configured such that the image processing portion 16 applies the original type determination processing and the segmentation processing for the image data that has been read from the image storage portion 15 and decoded by the coding/decoding portion 17 in the printing operation and the preview display operation. In addition, such an alternative method is also applicable in sending image data such as sending by facsimile or sending by internet FAX, which will be described below.

### <Facsimile Sending Operation>

Next, description will be given for a sending operation when image data of a read original is sent by facsimile. The facsimile image data is sent to the destination (sending destination) information set by the user operation from the touch panel 32 or the key operation portion 31. The destination information (telephone number in this example) is stored in the control memory 19 and is read as necessary. The destination information is generally stored as address book data so that information of a plurality of destinations is viewable and selectable, or is directly input before sending.

When the user operation to execute the facsimile sending is received by the operation panel 30, the main control portion 18 gives an instruction to the image storage portion 15, the image processing portion 16, the coding/decoding portion 17, the NCU 23, the modem 24, and the like to execute processing as will be described below. Note that, the main control portion 18 also gives an instruction to the reading portion 13 (original reading instruction), for example, when the operation to send the original by facsimile is performed. Note that, it is also possible to select image data to be sent and start sending the image data by facsimile while displaying a preview of the image data stored in the image storage portion 15.

The coding/decoding portion 17 reads and decodes the image data to be printed, and original determination data and segmentation data corresponding thereto from the image storage portion 15, which is provided to the image processing portion 16. The image processing portion 16 executes various image processings (hereinafter, referred to as image processing for facsimile sending) for the decoded image data (RGB image data). As will be schematically described below, examples of the image processing for facsimile sending include image quality adjustment processing, spatial filtering processing, scaling processing, output tone correction processing, and halftone generation processing. Each of the spatial filtering processing and the halftone generation processing may be the processing in accordance with various areas indicated by the segmentation data, respectively, but the segmentation data may not be used. Further, in the original reading operation following the facsimile sending, the segmentation processing for the read image data and coding and storage of the segmentation data may not be executed.

As the image quality adjustment processing, the decoded image data is converted into K data using a matrix coefficient. In this case, a matrix coefficient in accordance with an original type indicated by the original determination data maybe used. As the spatial filtering processing, enhancement processing or smoothing processing is performed for the K data. As the scaling processing, image enlarging processing and image reducing processing in accordance with a sending resolution set by the operation panel 30 or a sending resolution set as default are performed for the K data after the application of the spatial filtering processing. As the output tone correction processing, output γ correction processing intended to output to a recording medium such as recording paper at a sending destination, for example, is performed for the K data after the application of the scaling processing. Actually, not output γ correction processing for a device of the sending destination but output γ correction processing for a general device may be performed. As the halftone generation processing, binarization by error diffusion processing, for example, is performed for the K data after the application of the output tone correction processing. In the output tone correction processing and the halftone generation processing, processing in accordance with an original type indicated by the original determination data may be performed.

Description has been given for the facsimile sending of the monochromatic image, but when a color image is sent by facsimile, the image processing portion 16 may perform processing of converting the decoded image data into L*a*b* data for color transmission using a matrix coefficient as the image quality adjustment processing in the above-described image processing for facsimile sending so that the subsequent processing is performed for the L*a*b* data.

The image data after the application of the halftone generation processing is processed by rotating processing as necessary and is compressed and coded by the coding/decoding portion 17 with a compression format for the facsimile sending to be temporarily stored in the image storage portion 15. The modem 24 performs sending procedure to a sending destination set through the NCU 23, and at the time when communication with the sending destination is established (at the time ready for sending), the temporarily stored and coded K data is read and sequentially sent to the sending destination through the public network after necessary processing such as changing of the compression format.

The digital multi-functional peripheral 1 of the present invention is capable of sending image data to be sent with additional information such as transmission source information added thereto. The additional information added to the image data is an additional image. The additional information may be stored in the control memory 19. In addition, a plurality pieces of additional information may be stored in the control memory 19 and additional setting information may be stored in the control memory 19. The additional setting information at least includes the information showing a position to add to the image data to be sent (adding position), and when a plurality pieces of additional information are stored, the information about which one is to be selected is also included.

In the case of the facsimile sending with additional information added, synthesizing processing may be performed as follows. The main control portion 18 reads additional information and the information showing an adding position, which is converted into image data by the main control portion 18 or the image processing portion 16, and the image processing portion 16 synthesizes the converted image data (image data of additional information) at the above-described adding position in image data of the adding destination which is image data after the application of the scaling processing. In the digital multi-functional peripheral 1 of the present invention, the position at which the image data of the additional information is added to the image data after the application of the scaling processing is defined as being settable by a user from the operation panel 30 while performing the preview display as will be described below. The synthesized image data is processed by the above-described output tone correction processing, rotating processing, and compression processing, etc., and thereafter sent to the sending destination.

### <Preview Display Operation for Image Data to be Sent by Facsimile>

It is essential that the digital multi-functional peripheral 1 of the present invention has a configuration allowing image data to be sent by facsimile sending or the like to be displayed for previewing. The preview display operation is performed, for example, when the previous setting or the user operation to execute sending after confirming the image data before sending in advance is performed. Description will be given for the preview display operation for the image data to be sent by facsimile based on the facsimile sending operation for the same image data. In the preview display operation, the main control portion 18 also gives an instruction to the panel control portion 11.

In the preview display operation, the image processing portion 16 may perform the same processing as in the facsimile sending up to the image quality adjustment processing, the spatial filtering processing, and the scaling processing, and the preview image generation processing may be executed by the preview image generating portion 16a and the output γ correction processing for displaying the image data may be performed as the output tone correction processing. As the preview image generation processing, the preview image generating portion 16a performs conversion processing in accordance with a pixel number (display resolution) of the touch panel 32 and scaling processing in accordance with a reducing/enlarging ratio in the preview display for image data after the application of the image enlarging processing and the image reducing processing in accordance with a sending resolution to thereby generate data of the preview image. Note that, in the preview display operation, the spatial filtering processing may not be executed and the halftone generation processing is not executed.

R′G′B′ data generated by the preview image generating portion 16a and dealt with by means of the output tone correction processing is provided to the touch panel 32. The panel control portion 11 performs control for the touch panel 32 to display an image corresponding to the R′G′B′ data in a state of being incorporated in a GUI image to display the GUI image on the touch panel 32.

### <Sending Operation for Image Data via Internet>

Next, description will be given for a sending operation when image data of a read original is sent by an electronic mail or internet FAX via the internet. Such image data to be sent via the internet is also sent to sending destination information (electronic mail address in this example) set by the user operation from the touch panel 32 or the key operation portion 31 and stored in the control memory 19.

When the user operation concerning the sending via the internet is received by the operation panel 30, the main control portion 18 gives an instruction to the format converting portion 14, the image storage portion 15, the image processing portion 16, the coding/decoding portion 17, the LAN control portion 21, and the like to execute sending processing via the internet as will be described below. Note that, the main control portion 18 also gives an instruction to the reading portion 13 (original reading instruction), for example, when an operation to send an original via the internet is performed.

The coding/decoding portion 17 reads and decodes image data to be printed and original determination data and segmentation data corresponding thereto from the image storage portion 15, which is provided to the image processing portion 16. The image processing portion 16 executes various image processings (hereinafter, referred to as image processing for internet sending) for the decoded image data (RGB image data). Examples of the image processing for internet sending include the image quality adjustment processing, the spatial filtering processing, the scaling processing, the output tone correction processing, and the halftone generation processing, which have been described in the image processing for facsimile sending.

Moreover, the image processing in the case of color image sending is also the same as the image processing for facsimile sending, and in the image processing for internet sending, the image processing portion 16 may perform processing of converting the decoded image data into L*a*b* data for color transmission using a matrix coefficient as the image quality adjustment processing so that the subsequent processing is performed for the L*a*b* data.

The coding/decoding portion 17 codes (compresses) the image data dealt with by means of the image processing for internet sending to obtain compressed files. The compression is performed in the unit of a single page of the original. Subsequently, the format converting portion 14 converts the compressed files into a single file and the file is attached to a multipart mail according to MIME (Multipurpose Internet Mail Extension), for example. By the processing so far, the read image data is converted into a format of an electronic mail. The electronic mail is sent to a sending destination via the internet using a mail transfer protocol such as an SMTP (Simple Mail Transfer Protocol) through a LAN interface by the LAN control portion 21.

In the case of the internet facsimile sending, the coding/decoding portion 17 may perform the compression in a compression format only for facsimile such as MH, for example, and the format converting portion 14 may convert the obtained compressed files in the unit of a page, for example, into a single TIFF file. In the case of sending just by attaching to the electronic mail as an attached file (in the case of sending by so-called scan to e-mail), the coding/decoding portion 17 may perform the compression in a compression format such as JPEG, for example, and the format converting portion 14 may convert the obtained compressed files in the unit of a page into a single PDF file, for example.

In addition, even when image data to be sent is image data sent via the internet, the digital multi-functional peripheral 1 of the present invention is capable of sending the image data with additional information such as transmission source information added thereto in the same manner as the case of the facsimile sending image data. As the additional information adding processing, the synthesizing processing described in the facsimile sending may be executed, and the image data is dealt with by means of the output tone correction processing, the compression processing, the format conversion processing, and the like described above and thereafter sent to an address of a sending destination as an electronic mail.

### <Preview Display Operation for Image Data to be Sent via Internet>

As well as mentioned in the description for the preview display in the facsimile sending, the digital multi-functional peripheral 1 of the present invention is capable of being configured so that a preview of image data to be sent via the internet can also be displayed on the touch panel 32.

In the preview display operation, as well as mentioned in the description for the preview display in the facsimile sending, the image processing portion 16 may perform the same processing as in the image processing for internet sending up to the image quality adjustment processing, the spatial filtering processing, and the scaling processing, and the preview image generation processing may be executed by the preview image generating portion 16a, and the output γ correction processing for displaying the image data may be performed as the output tone correction processing. R′G′B data generated by the preview image generating portion 16a and dealt with by means of the output tone correction processing is provided to the touch panel 32 and is displayed on the touch panel 32 in a state of being incorporated in a GUI image by the panel control portion 11. The description for the preview display in the facsimile sending may be also quoted for synthesizing of information showing an adding position or additional information.

<Description for Preview Display before Sending Image Data>

As has been described for the preview display operation in the facsimile sending and in the image data sending via the internet, the digital multi-functional peripheral 1 according to the present invention has the preview image generating portion 16a that reads at least image data to be sent from the image storage portion 15 and generates a preview image thereof. The preview image generated by the preview image generating portion 16a is sent to the touch panel 32 by the control from the main control portion 18, controlled to be displayed in a state of being incorporated in a GUI image by the panel control portion 11, and displayed on the touch panel 32. In this manner, the touch panel 32 is an example of an image display portion that displays a preview of the image data to be sent.

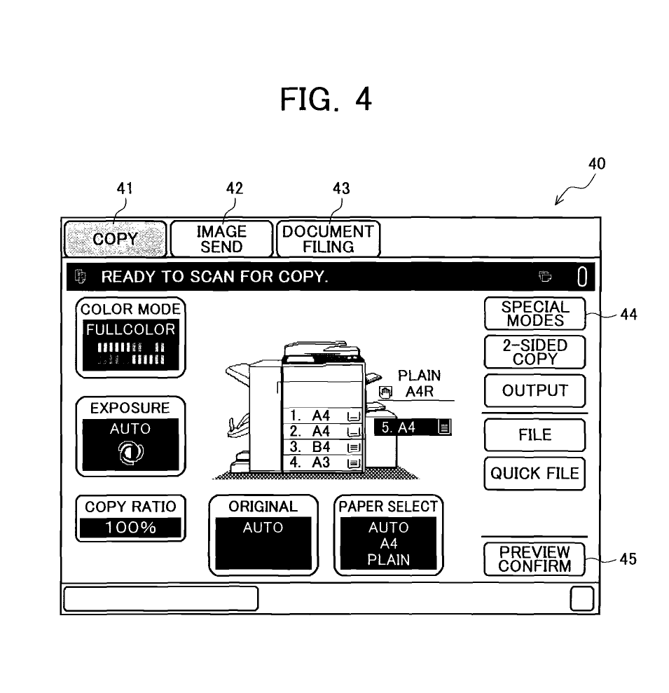

FIG. 4 is a diagram for showing an example of a standard screen of the digital multi-functional peripheral. A standard screen 40 is displayed on the touch panel 32 of the digital multi-functional peripheral 1 when a power source of the digital multi-functional peripheral 1 is turned on or reset. On the standard screen 40, a copy mode is selected by a copy tab 42 so that various condition settings for performing a copy are possible. A preview confirm key 41 is displayed on the standard screen 40, and the user is able to display a preview of image data by operating the preview confirm key 41 using the touch panel 32. Note that, when an image send tab 43 is selected, shifting to an image send mode is performed and the standard screen 40 is switched to a screen on which various condition settings are performed to perform the image send, and when a document filing tab 44 is selected, shifting to a document filing mode is performed and the standard screen 40 is switched to a screen on which various condition settings are performed to perform the document filing.

The image data displayed for previewing at this time is image data of an original image read by the reading portion 13 (FIG. 2) and stored in the image storage portion 15. In addition, image data received from an external device by facsimile, internet FAX, or the like and stored in the image storage portion 15 may also be a target for the preview.

For example, when trying to copy an original, the user sets the original on the reading portion 13 and firstly operates the preview confirm key 41. Then, by depressing the start key 31d (FIG. 3) to start the copy, the original image is read and a preview of image data stored in the image storage portion 15 is displayed. Alternatively, when performing an operation of printing image data received from an external device, the preview confirm key 41 is depressed and the start key 31d is then depressed so that a preview of the image data can be displayed.

### <Description for Preview Display According to the Present Invention>

In the digital multi-functional peripheral 1 having the configuration as described above, the major characteristic feature of the present invention resides in that, in sending image data, destination confirmation is performed before a preview display so that unnecessary setting change processing is not performed for an incorrect destination. Therefore, the digital multi-functional peripheral 1 is configured so as to be provided with the touch panel 10 corresponding to a display portion that displays various pieces of information, the reading portion 13 corresponding to an original reading portion that reads an original and inputs image data, the NCU 23 or the LAN control portion 21 (hereinafter represented by the NCU 23) corresponding to an image sending portion that sends input image data, the preview image generating portion 16a that generates a preview image of image data, and the panel control portion 11 corresponding to a display control portion that causes the touch panel 10 to display a preview image of image data before performing image sending by the NCU 23.

When an instruction to start reading of an original by the user is received, the panel control portion 11 causes the touch panel 10 to display a sending destination confirmation screen for confirming a sending destination of image data, and causes the touch panel 10 to display a preview image of the image data after confirmation input is performed by the user to the sending destination confirmation screen.

This makes it possible to perform the destination confirmation before the preview display in sending the image data, thus preventing the user from executing unnecessary setting change processing to an incorrect destination while viewing the preview.

The panel control portion 11 is also capable of executing the processing of causing the touch panel 10 to display the sending destination confirmation screen in parallel with original reading processing by the reading portion 13 and preview image generation processing by the preview image generating portion 16a.

Since the user is able to perform the sending destination confirmation during processing time for the original reading and the preview image generation in this manner, it is possible to perform the sending destination confirmation efficiently without wasting time.

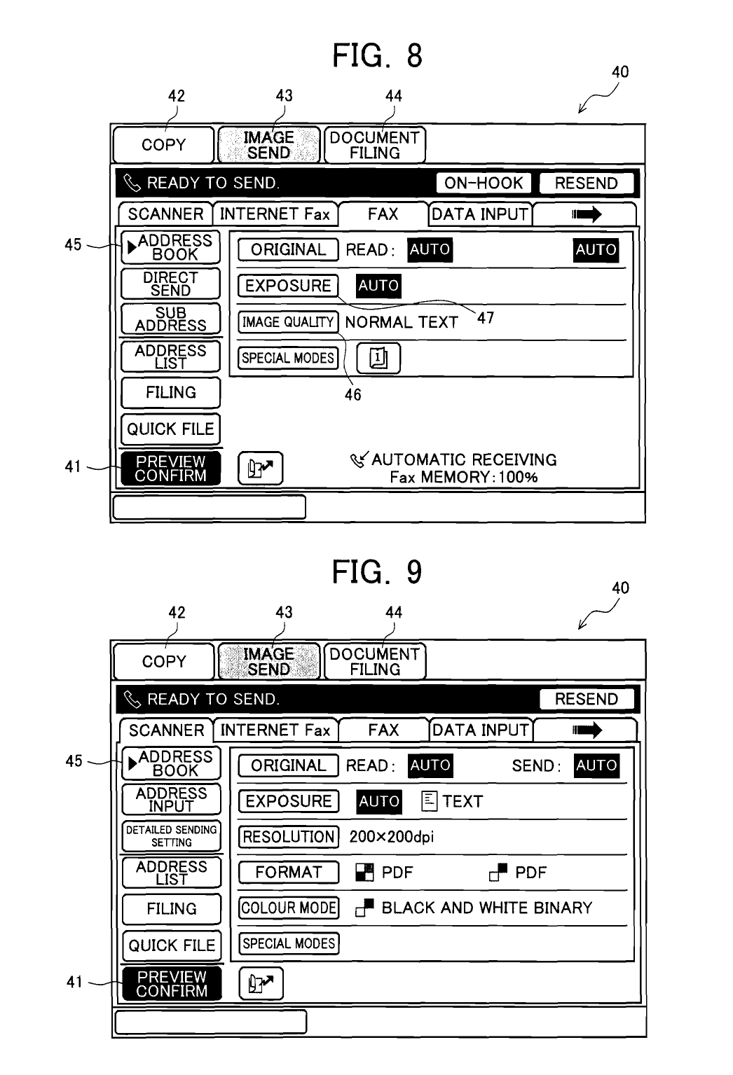

Description will hereinafter be given for the flow of the preview display processing by the digital multi-functional peripheral 1 according to the present invention in association with exemplary screen displays thereof. Note that, the following exemplary screen displays (FIGS. 8 to 16) show an exemplary display of the touch panel 32 in the digital multi-functional peripheral 1 which is an embodiment of the present invention.

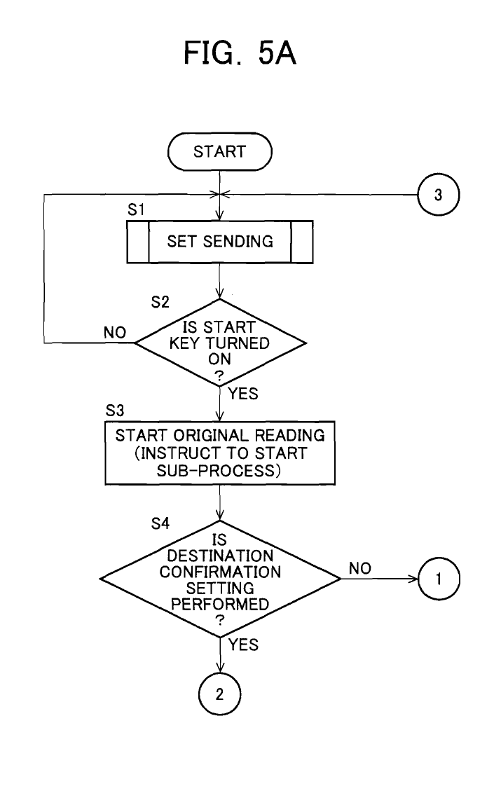

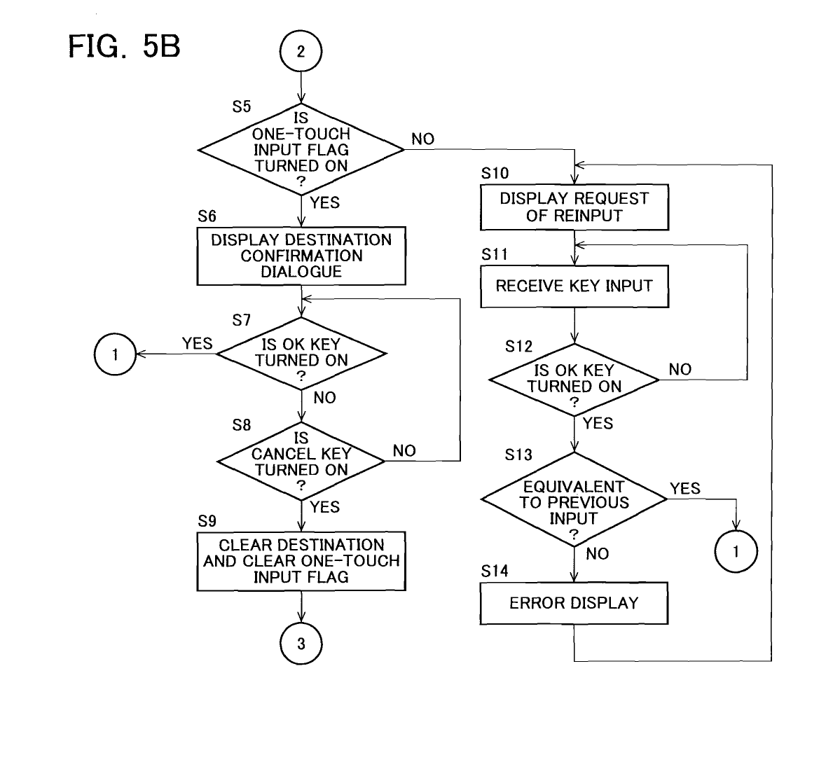

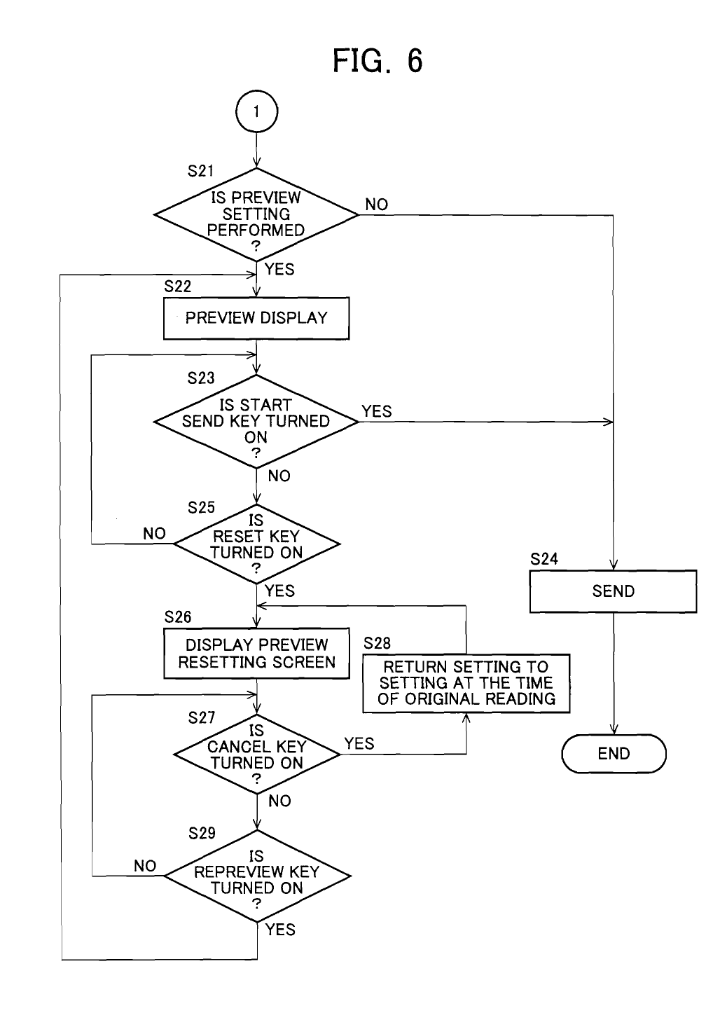

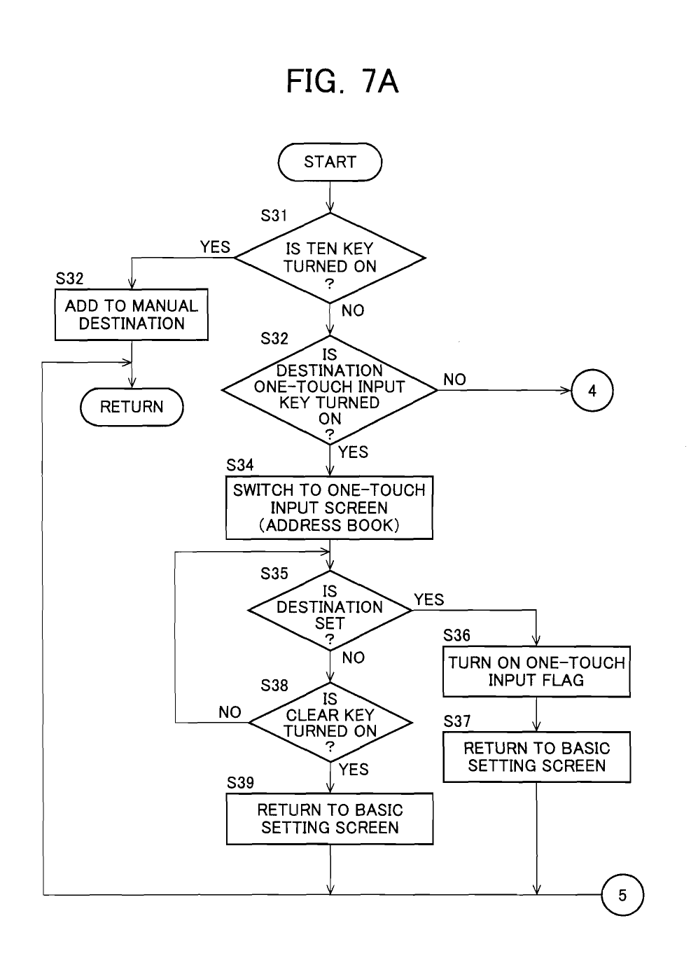

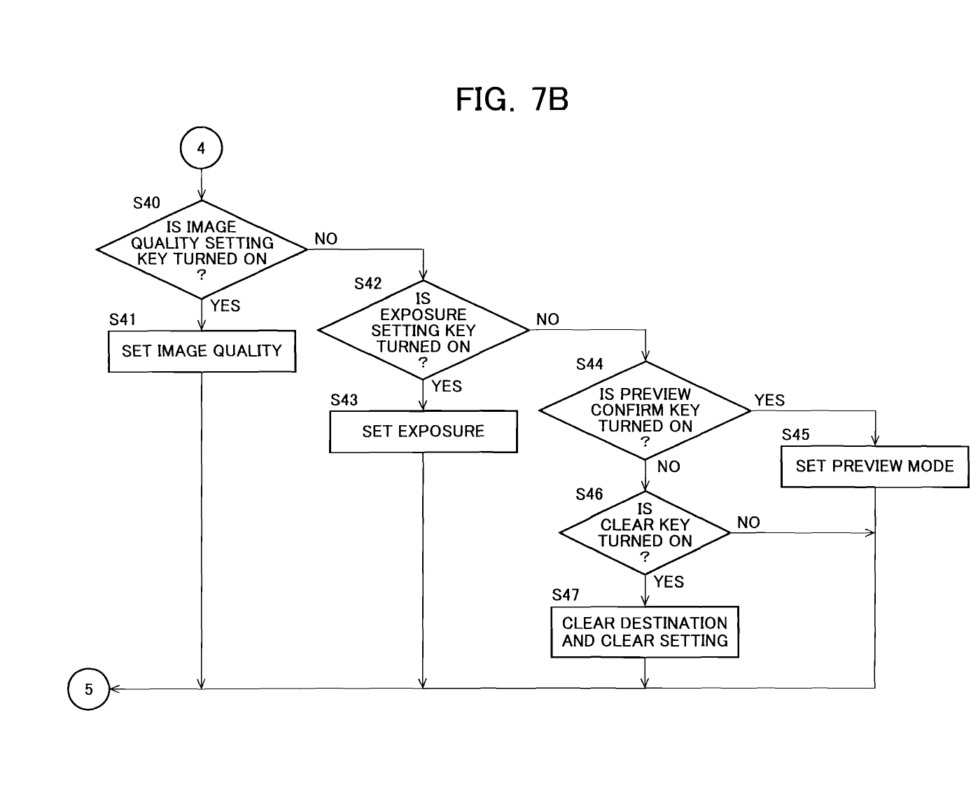

FIGS. 5A to 7B are flowcharts for explaining an example of preview display processing by the digital multi-functional peripheral 1 of the present invention. FIG. 6 shows the flow subsequent to the flow shown in FIGS. 5A and 5B, and FIGS. 7A and 7B show the detailed flow of processing at step S1 shown in FIG. 5A. Note that, this example explains a case where an image send mode is selected by the image send tab 43 on the standard screen 40 shown in FIG. 4 and a facsimile send mode included in the image send mode is further selected. In the case of the facsimile send mode, the standard screen 40 shown in FIG. 8 below is displayed.

In FIG. 5A, the digital multi-functional peripheral 1 firstly sets sending conditions (exposure and image quality, etc.,) in facsimile sending based on the user operation in a state where the standard screen 40 shown in FIG. 8 is displayed (step S1). Subsequently, it is determined whether or not the start key 31d (FIG. 3) of the operation panel 30 is depressed by the user (step S2), and if it is determined that the start key 31d is depressed (in the case of YES), the main control portion 18 instructs the reading portion 13 to start original reading processing and instructs the preview image generating portion 16a to start processing of generating a preview image (sub-process) at the same time (step S3). Alternatively, if it is determined at step S2 that the start key 31d is not depressed (in the case of NO), the procedure returns to step S1 to repeat processing.

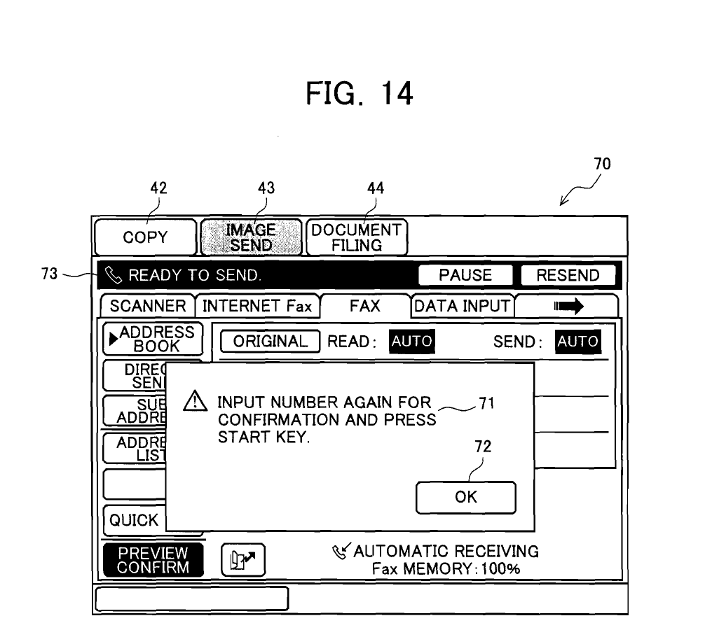

Subsequently, the main control portion 18 determines whether or not a destination confirmation setting is performed (step S4), and if it is determined that the destination confirmation setting is performed (in the case of YES), it is determined whether or not a one-touch input flag is turned on in FIG. 5B (step S5). Alternatively, when the destination confirmation setting is not performed at step S4 (in the case of NO), the procedure proceeds to step S21 shown in FIG. 6. Note that, the above-described destination confirmation setting is to set whether or not to display a destination confirmation dialogue shown in FIG. 13 or 14 below and can be set on a not-shown system setting screen.

Then, if it is determined at step S5 of FIG. 5B that the one-touch input flag is turned on by the main control portion 18 (in the case of YES), the panel control portion 11 causes the touch panel 32 to display the destination confirmation dialogue shown in FIG. 13 below (step S6). Alternatively, if it is determined at step S5 that the one-touch input flag is not turned on by the main control portion 18 (in the case of NO), the panel control portion 11 causes the touch panel 32 to display the destination confirmation dialogue shown in FIG. 14 below to request to reinput a destination (step S10).

Then, with respect to the destination confirmation dialogue 61 (FIG. 13) displayed at step S6, the main control portion 18 determines whether or not an OK key 62 on the destination confirmation dialogue 61 is turned on (step S7), and if it is determined that the OK key 62 is turned on (in the case of YES), the procedure proceeds to step S21 shown in FIG. 6. Alternatively, if it is determined at step S7 that the OK key 62 is not turned on (in the case of NO), it is determined whether or not a cancel key 63 on the destination confirmation dialogue 61 is turned on (step S8). If it is determined that the cancel key 63 is turned on (in the case of YES), the destination and the one-touch input flag are cleared (step S9) and the procedure returns to step S1 of FIG. 5A. Alternatively, if it is determined that the cancel key 63 is not turned on (in the case of NO), the procedure returns to step S7 to repeat processing.

Further, to the request to reinput a destination of the destination confirmation dialogue 71 (FIG. 14) displayed at step S10, the main control portion 18 receives key input for the reinput from a ten key or the like (step S11) and determines whether or not an OK key 72 on the destination confirmation dialogue 71 is turned on (step S12). If it is determined that the OK key 72 is turned on (in the case of YES), it is determined whether or not the reinput number matches a destination number that has been already input (previous input) (step S13). Alternatively, if it is determined that the OK key 72 is not turned on (in the case of NO), the procedure returns to step S11 to repeat processing.

Then, if it is determined at step S13 that the reinput destination number matches the previously input destination number (in the case of YES), the procedure proceeds to step S21 shown in FIG. 6. Alternatively, if it is determined that the reinput destination number dose not match the previously input destination number (in the case of NO), the panel control portion 11 performs an error display (step S14) and the procedure returns to step S10 to repeat processing.

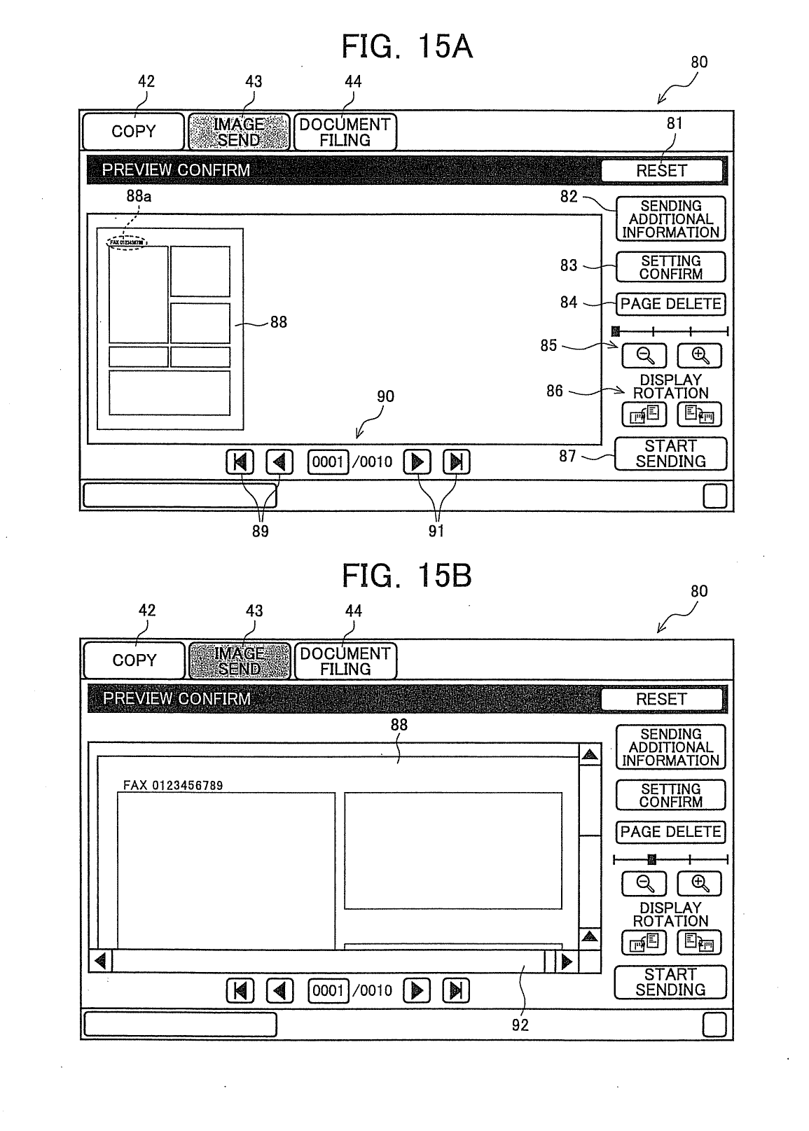

In FIG. 6, the main control portion 18 determines whether or not the preview confirm key 41 is turned on to perform a preview display setting on the standard screen 40 shown in FIG. 8 (step S21), and if it is determined that the preview display setting is not performed (in the case of NO), the procedure proceeds to step S24 to convert image data read by the reading portion 13 into FAX sending data and send the converted image data. Alternatively, if it is determined at step S21 that the preview display setting is performed (in the case of YES), the panel control portion 11 waits for completion of the sub-process for generating a preview image that is started at the above-described step S3 and causes the touch panel 32 to display a preview display screen 80 shown in FIGS. 15A and 15B below (step S22).

When the preview image of the image data is displayed at step S22, if the destination confirmation setting is performed at step S4, a specific area of the image data that is previously designated by the user may be enlarged and displayed. For example, in the case of the preview display screen 80, an upper left area 88a of a first page of original is enlarged and displayed as an area in which a destination (facsimile number) is described. In this manner, by previously designating an area in which a destination is more likely to be described on an original by the user to enlarge and display a preview of the area, it is possible to perform the sending destination confirmation by the user reliably in addition to the destination confirmation dialogue.

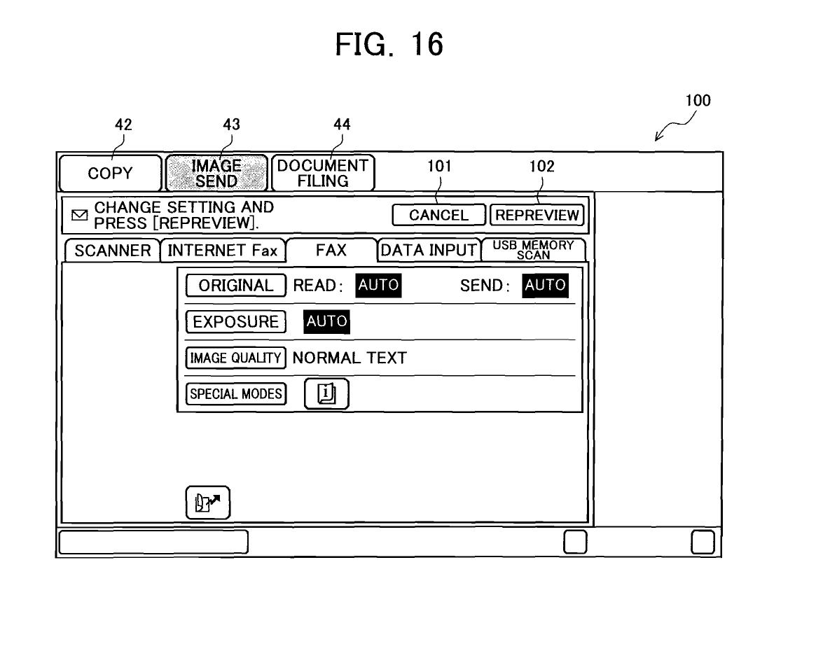

Then, the main control portion 18 determines whether or not a start send key 87 (corresponding to an image send key) in the preview display screen 80 shown in FIGS. 15A and 15B is turned on (step S23), and if it is determined that the start send key 87 is turned on (in the case of YES), the image data read by the reading portion 13 is converted into FAX sending data and the converted image data is sent (step S24). Alternatively, if it is determined at step S23 that the start send key 87 is not turned on (in the case of NO), it is determined whether or not a reset key 81 in the preview display screen 80 is turned on (step S25). If it is determined that the reset key 81 is turned on (in the case of YES), the panel control portion 11 displays a preview resetting screen 100 shown in FIG. 16 below on the touch panel 32 (step S26). Alternatively, if it is determined that the reset key 81 is not turned on (in the case of NO), the procedure returns to step S23 to repeat processing.

Then, the main control portion 18 determines whether or not a cancel key 101 in the preview resetting screen 100 displayed at step S26 is turned on (step S27), and if it is determined that the cancel key 101 is turned on (in the case of YES), the facsimile sending setting is returned to a setting at the time of original reading (step S28), and the procedure returns to step S26 to repeat processing. Alternatively, if it is determined at step S27 that the cancel key 101 is not turned on (in the case of NO), it is determined whether or not a repreview key 102 in the preview resetting screen 100 is turned on (step S29). If it is determined that the repreview key 102 is turned on (in the case of YES), the procedure returns to step S22 to repeat processing. Alternatively, if it is determined that the repreview key 102 is not turned on (in the case of NO), the procedure returns to step S27 to repeat processing.

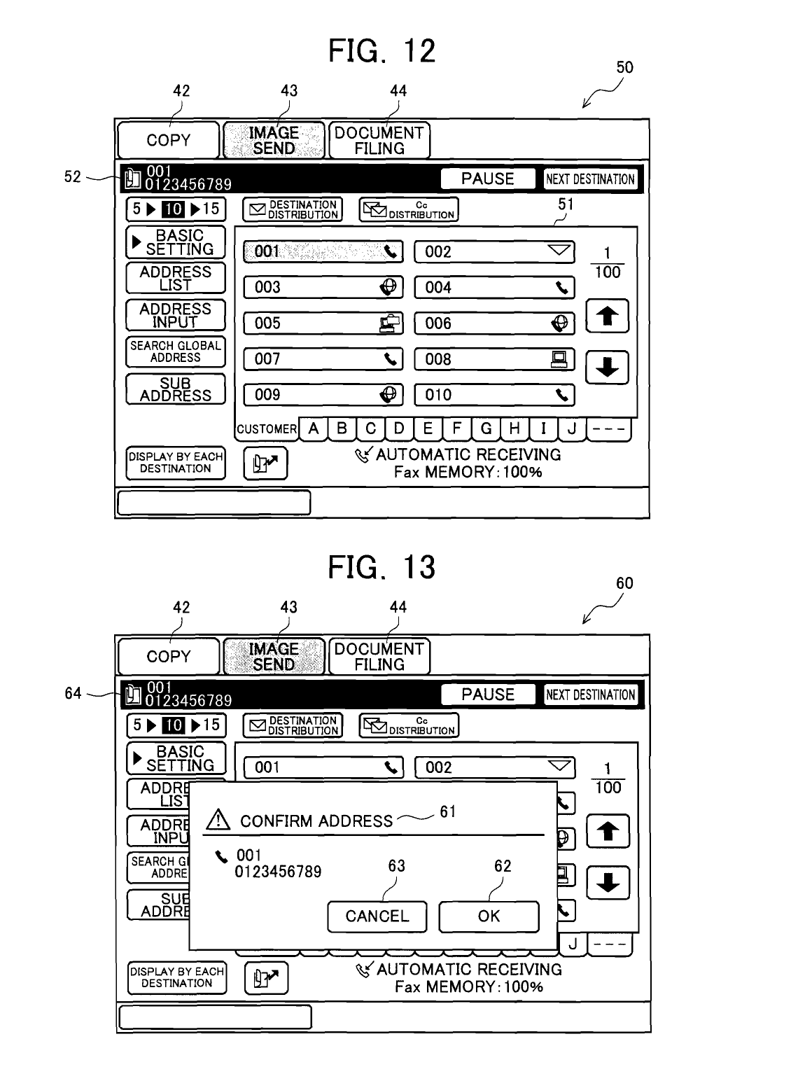

In FIGS. 7A and 7B, description will be given in detail for sending setting processing at step S1 shown in FIG. 5A. Here, description will be given with reference to the standard screen 40 of a facsimile send mode shown in FIG. 8. In the facsimile send mode, read image data can be sent by facsimile. In FIG. 7A, the main control portion 18 firstly determines whether or not the ten key 31a (FIG. 3) of the operation panel 30 is turned on based on the user operation in a state where the standard screen 40 shown in FIG. 8 is displayed (step S31), and if it is determined that the ten key 31a is turned on (in the case of YES), additional storage is performed as destination information that is manually input by the ten key 31a (step S32). Alternatively, if it is determined at step S31 that the ten key 31a is not turned on (in the case of NO), it is determined whether or not a destination one-touch input key (corresponding to an address book key 45 in FIG. 8) is turned on (step S33). If it is determined that the destination one-touch input key is turned on (in the case of YES), the display is switched to a one-touch input screen (address book screen 50) shown in FIG. 12 below (step S34). Alternatively, if it is determined that the destination one-touch input key is not turned on (in the case of NO), it is determined whether or not an image quality setting key 46 is turned on in FIG. 7B (step S40).

Then, the main control portion 18 determines whether or not any of destination information is selected and a destination is set in a state where the one-touch input screen shown in FIG. 12 is displayed (step S35), and if it is determined that the destination is set (in the case of YES), the one-touch input flag is turned on (step S36) and the display screen is returned to a basic setting screen (that is, the standard screen shown 40 in FIG. 8) (step S37). Alternatively, if it is determined that the destination is not set (in the case of NO), it is determined whether or not a clear key (corresponding to the clear key 31b of FIG. 3) is turned on (step S38). If it is determined that the clear key is turned on (in the case of YES), the display screen is returned to the basic setting screen (step S39) and the procedure proceeds to step S31. Alternatively, if it is determined that the clear key is no turned on (in the case of NO), the procedure returns to step S35 to repeat processing.

Subsequently, in FIG. 7B, if it is determined at step S40 that the image quality setting key 46 is turned on (in the case of YES), the main control portion 18 displays a image quality setting window (not-shown) to receive setting input (step S41). Alternatively, if it is determined at step S40 that the image quality setting key 46 is not turned on (in the case of NO), it is determined whether or not an exposure setting key 47 is turned on (step S42).

Then, if it is determined that at step S42 that the exposure setting key 47 is turned on (in the case of YES), the main control portion 18 displays an exposure setting window (not-shown) to receive setting input (step S43). Alternatively, if it is determined at step S42 that the exposure setting key 47 is not turned on (in the case of NO), it is determined whether or not the preview confirm key 41 in the screen is turned on (step S44).

Then, if it is determined at step S44 that the preview confirm key 41 is turned on (in the case of YES), the main control portion 18 sets a preview mode (step S45). Alternatively, if it is determined at step S44 that the preview confirm key 41 is not turned on (in the case of NO), it is determined whether or not the clear key 31b (FIG. 3) is turned on (step S46).

Then, if it is determined at step S46 that the clear key 31b is turned on (in the case of YES), the main control portion 18 clears the destination and various settings (step S47). Alternatively, if it is determined at step S46 that the clear key 31b is not turned on (in the case of NO), the procedure is directly returned.

FIGS. 8 to 11 are diagrams for showing an example of a standard screen of an image send mode. The user is able to display the standard screen 40 corresponding to each mode to perform various sending settings. The standard screen 40 is provided with the preview confirm key 41 for setting a preview mode, tabs 42 to 44 for switching operation modes, and the address book key 45 for displaying an address book.

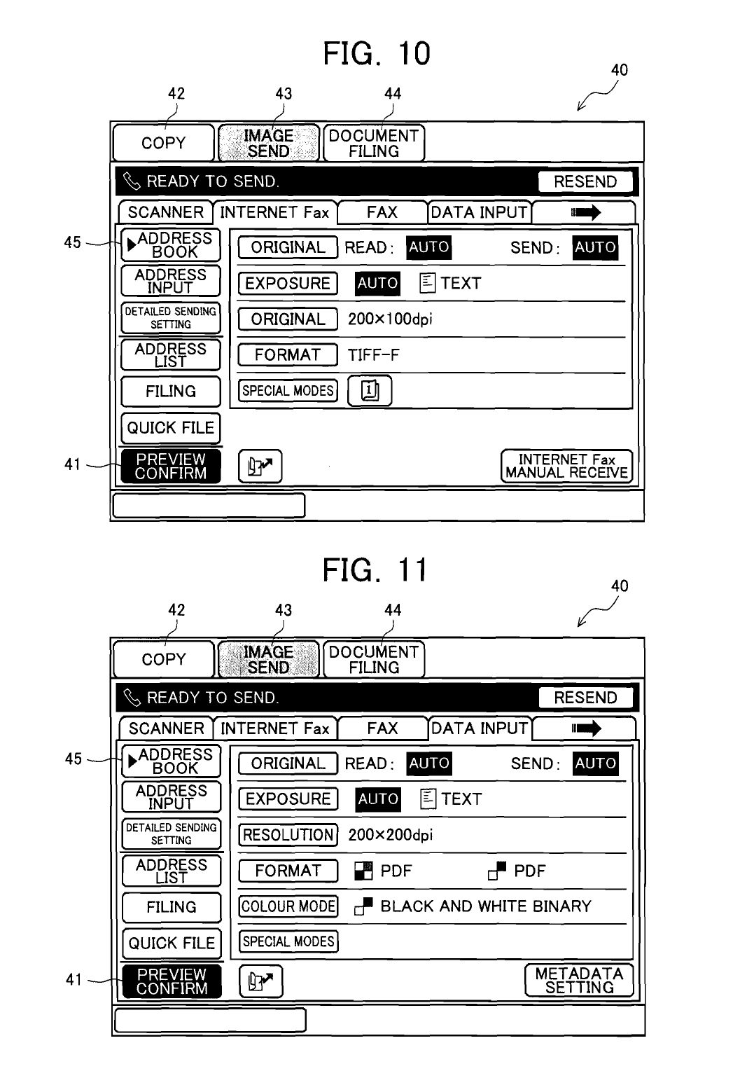

The standard screen 40 shown in FIG. 8 is a screen corresponding to a facsimile send mode for sending image data by facsimile, the standard screen shown in FIG. 9 is a screen corresponding to an electronic mail send (scanner) mode for sending image data by attaching to an electronic mail, the standard screen 40 shown in FIG. 10 is a screen corresponding to an internet facsimile send mode for sending image data by internet facsimile, and the standard screen 40 shown in FIG. 11 is a screen corresponding to an external file server send (data input) mode for sending image data to an external file server.

FIG. 12 is a diagram for showing an example of an address book screen on which one-touch input of a destination is possible, where 50 denotes an address book screen. The address book screen 50 is displayed on the touch panel 32 when the address book key 45 on the standard screen 40 shown in FIGS. 8 to 11 is depressed. The address book screen 50 is provided with an address list 51 in which destination (address) information of sending destinations is made into a list and an address display portion 52 that displays address information currently selected from the address list 51. In this example, “001” is selected from the address list 51 as address information and a destination number (0123456789) of “001” is displayed on the address display portion 52. Note that, as the address information, not only facsimile numbers but also electronic mail addresses and the like may be also registered.

In the above, when the address list 51 in which address information of sending destinations of image data is made into a list is displayed on the touch panel 32 so as to be selectable by the user, the panel control portion 11 prohibits to select a plurality pieces of address information from the address list 51. That is, only one address information is allowed to be selected from the address list 51, and when one piece of address information is selected, it is controlled such that other pieces of address information are displayed in a gray-out manner, for example, so as not to be selected. Thereby, although it is impossible to send data to a plurality of destinations at the same time, it is effective when it is desired to send a confidential document or the like only to a specific destination reliably.

FIG. 13 is a diagram for showing an example of a destination confirmation screen displayed at the time of destination one-touch input, where 60 denotes a destination confirmation screen. The destination confirmation screen 60 is provided with the destination confirmation dialogue 61 for prompting address confirmation and a address display portion 64 for displaying an already-set destination address. The cancel key 63 and the OK key 62 are displayed in the destination confirmation dialogue 61, and when the OK key 62 is turned on by the user, the already-set destination address is decided to perform a preview display. On the other hand, when the cancel key 63 is turned on by the user, the already-set destination address is cleared to set a destination address again from the address book screen.

FIG. 14 is a diagram for showing an example of a destination confirmation screen displayed at the time of destination manual input, where 70 denotes a destination confirmation screen. The destination confirmation screen 70 is provided with the destination confirmation dialogue 71 including a message for prompting reinput for address confirmation and an address display portion 73 for displaying an already-set destination address. In this example, “8531459” has been already input as a destination number and “8531459” is displayed on the address display portion 72.

The operation panel 30 shown in FIG. 3 is provided with an input portion for inputting at least one or more of text, numeral, and symbol. For example, the numeral can be input from the ten key 31a and the text and the symbol can be input by displaying a keyboard (not-shown) on the touch panel 32. When the user inputs a destination address of a sending destination of image data by the input portion (that is, in the case of not one-touch input but manual input), the panel control portion 11 causes the destination confirmation dialogue 71 to display a message for requesting to reinput a destination address.

Moreover, the OK key 72 is displayed in the destination confirmation dialogue 71, and when the OK key 72 is turned on by the user after the reinput of the destination address, it is determined whether or not the already-set destination address matches the reinput destination address. When both of them are equivalent, a preview display is performed, and when both of them are different from each other, an error display is performed so that the user is able to reinput a destination address. Note that, when the destination addresses do not match a predetermined number of times, processing of clearing the destination and various settings to return to an initial state may be performed.

FIGS. 15A and 15B are diagrams for showing an example of a preview display screen, where 80 denotes a preview display screen. FIG. 15A shows an example of a normal preview display and FIG. 15B shows an example of a preview display with twice magnification. After various settings such as settings of a destination and an original are performed and the preview confirm key 41 is turned on on the standard screen 40 shown in FIGS. 8 to 11, when the start key 31d (FIG. 3) of the operation panel 30 is depressed, an original set on a document table or a document feeder is started to be read and the destination confirmation dialogue shown in FIG. 13 or 14 is displayed, then the preview display screen 80 is displayed. Note that, when a dialogue message of “Original is being read.” is displayed simultaneously with original reading and image processing of a first sheet of read original is completed, shifting to the preview display screen 80 is performed. Also in the case of during original reading, the shifting may be performed after a preview image is generated.

When the preview image of the image data is displayed, if the destination confirmation setting is performed, a specific area of the image data previously designated by the user may be enlarged and displayed. For example, the upper left area 88a of a first page of the original is enlarged and displayed as an area in which a destination (facsimile number) is described. In this manner, by previously designating an area in which a destination is more likely to be described on the original by the user to enlarge and display a preview of the area, it is possible to perform the sending destination confirmation by the user reliably in addition to the destination confirmation dialogue.

In FIGS. 15A and 15B, the preview display screen 80 is provided with the reset key 81, a sending addition display key 82, a setting confirm key 83, a page delete key 84, an enlarging/reducing key 85, a display rotation key 86, the start send key 87, a preview image 88, page shift keys 89 to 91, and a scroll bar 92.

The reset key 81 is a key to open a resetting screen shown in FIG. 16 below and is turned on when a setting is changed after confirming the preview screen. The sending addition display key 82 is a key to display the notification of the information added on a preview image in sending (for example, transmission source information, etc.), and, for example, can be depressed only in the case of “full screen display” and is displayed in a gray-out manner in reducing/enlarging display. The sending addition display key 82 is active when a facsimile send mode or an internet facsimile send mode is set and a transmission source printing setting is turned on, and is displayed in a gray-out manner when the transmission source printing setting is turned off. Moreover, the sending addition display key 82 is not displayed in other send modes.

The setting confirm key 83 is a key to display setting contents set in the digital multi-functional peripheral 1. The page delete key 84 is a key to open a page delete screen and performs page deletion by selecting any of “delete displayed page”, “delete designated page”, and “delete all pages”. The “delete displayed page” is selected in a normal state. The enlarging/reducing key 85 is a key to enlarge/reduce a preview image and has four kinds of selectable menus including “full screen display”, “twice magnification”, “four-times magnification”, “eight-times magnification”, for example, and the default setting is “twice magnification”. The enlarging/reducing is reflected not in the unit of a page but on the whole data, and the setting of enlarging/reducing is also held when page shift or display rotation is performed.

The display rotation key 86 is a key to rotate a preview image to the left or right by 90° in a case where a direction of the preview image is in a lateral direction, or the like, and the display rotation is reflected not in the unit of a page but on the whole data and the setting of the display rotation is also held when page shift or enlarging/reducing is performed. It is also possible to change the display at 90°, 180°, 270° and so on by keeping on depressing the key.

The start send key 87 corresponds to an image send key for starting sending of an image. When image sending is tried to be started by the start key 31d (FIG. 3) of the operation panel 30, it may occur that the image sending is performed before confirming a preview image. However, by trying to display the start send key 87 in the display screen of the preview image like in this example, the user is able to perform the image sending reliably after viewing the preview image.

In the preview image 88, a preview image of image data read from an original and input is displayed based on the sheet. Here, the state where the preview image is displayed based on upper left is shown. The page shift keys 89 to 91 are keys used when page shift is performed. 89 denote the keys for shifting to a backward direction, and the key for shifting to a first page and the key for shifting to a previous page are shown in this order from the left. 91 denote the keys for shifting to a forward direction, and the key for shifting to a last page and the key for shifting to a next page are shown in this order from the right. 90 denotes “page number of displayed preview image/total number of pages of preview image”. When “page number of displayed preview image” key (“0001” is displayed in this example) is depressed, shifting to a page number input screen is performed so that shifting to a page designated by the ten key is possible. When the preview display is performed by “full screen display”, the scroll bar 92 is displayed in a gray-out manner but, in the case of enlarging to display, varies as being enlarged.

FIG. 16 is a diagram for showing an example of a preview resetting screen, where 100 denotes a resetting screen. The resetting screen 100 is displayed when the reset key 81 shown in FIGS. 15A and 15B is depressed after a preview image is displayed. The resetting screen 100 is provided with the cancel key 101 for returning a sending setting to a setting at the time of original reading and the repreview key 102 for performing a preview display again after the resetting. When the reset key 81 is depressed to reset the sending setting item set in FIG. 8 after the preview image is displayed on the touch panel 32, the panel control portion 11 causes the touch panel 32 to display the sending setting item corresponding to the send mode. Since the contents of the sending setting is the facsimile send mode in this example, the sending setting item corresponding to the facsimile send mode (which has the same contents as that of the sending setting of FIG. 8) is displayed so that each item can be reset.

Similarly to the above, when the contents of the sending setting is the scanner mode, the sending setting item corresponding to the scanner mode (which has the same contents as that of the sending setting of FIG. 9) is displayed. When the contents of the sending setting is the internet FAX mode, the sending setting item corresponding to the internet FAX mode (which has the same contents as that of the sending setting of FIG. 10) is displayed. When the contents of the sending setting is the data input mode, the sending setting item corresponding to the data input mode (which has the same contents as that of the sending setting of FIG. 11) is displayed. In this manner, it is possible to reset the sending setting item for each of the send modes.

According to the present invention, the following effects may be obtained.

According to the present invention, it is possible to confirm a destination before a preview display in sending image data so that unnecessary setting change processing is not performed for an incorrect destination.

1. An image sending apparatus that includes a display portion for displaying various information; an original reading portion for reading an original and inputting image data; an image sending portion for sending the image data; a preview image generating portion for generating a preview image of the image data; and a display control portion for causing the display portion to display the preview image of the image data before performing image sending by the image sending portion, wherein
when an instruction to start original reading by a user is received, the display control portion causes the display portion to display a sending destination confirmation screen for confirming a sending destination of the image data, and
after confirmation input is performed by the user to the sending destination confirmation screen, causes the display portion to display the preview image of the image data.

2. The image sending apparatus as defined in claim 1, wherein
the display control portion executes processing of causing the display portion to display the sending destination confirmation screen in parallel with original reading processing by the original reading portion and preview image generation processing by the preview image generating portion.

3. The image sending apparatus as defined in claim 1 or 2, wherein
the image sending portion sends the image data by any of send modes including an electronic mail send mode for sending the image data by attaching to an electronic mail, a facsimile send mode for sending the image data by facsimile, an internet facsimile send mode for sending the image data by internet facsimile, and an external file server send mode for sending the image data to an external file server.

4. The image sending apparatus as defined in claim 1 or 2, wherein
an input portion for inputting at least one or more of text, numeral, and symbol is included, and
when the user inputs destination information of the sending destination of the image data by the input portion, the display control portion displays a message for requesting reinput of the destination information in the sending destination confirmation screen.

5. The image sending apparatus as defined in claim 1 or 2, wherein
when the display portion is caused to display a destination information list in which destination information of sending destinations of the image data is made into a list so as to be selectable by the user, the display control portion prohibits to select a plurality of destination information from the destination information list.

6. The image sending apparatus as defined in claim 3, wherein
when a sending setting item that is set to the image sending apparatus is reset after the display portion is caused to display the preview image, the display control portion causes the display portion to display a sending setting item corresponding to a send mode of the image sending portion.

7. The image sending apparatus as defined in claim 1 or 2, wherein
the display control portion displays an image send key in a display screen of the preview image.

8. The image sending apparatus as defined in claim 1 or 2, wherein
in displaying the preview image of the image data, the display control portion displays a specific area of the image data that is previously designated by the user after magnification.
